(19) United States
(12) Patent Application Publication
(10) Pub. No.: US 2026/0357043 A1
(43) Pub. Date: Nov. 12, 2026

(54) SCAVENGING OXYGEN

(71) Applicant: Colormatrix Holdings, Inc., Avon Lake, OH (US)

(72) Inventors: Catherine BLACKWELL, Knowsley (GB); Patrick BROWN, Knowsley (GB); Andrew ELKIN, Knowsley (GB); Adrian CARMICHAEL, Knowsley (GB); Tom BRENNAN, Knowsley (GB)

(21) Appl. No.: 19/121,668

(22) PCT Filed: Oct. 11, 2023
(86) PCT No.: PCT/IB2023/060223

§ 371 Date: Apr. 16, 2025

(30) Foreign Application Priority Data
Oct. 19, 2022 (GB) 2215452.0

(51) Int. Cl. C08K 11/00; B65D 81/26; C08G 63/672; C08J 11/06; C08K 5/095; C08K 5/103

(52) U.S. Cl. CPC C08K 11/00; B65D 81/26; C08G 63/672; C08J 11/06; C08K 5/095; C08K 5/103

(57) ABSTRACT

A formulation for scavenging oxygen comprises: (A) an oxygen-scavenging copolymer; and (B) an oil, wherein said oil is selected from, for example, olive oil, macadamia oil, avocado oil, bataua oil, gevuina oil and/or an oil comprising at least 20% of a glycerol oleate.

This invention relates to scavenging oxygen and particularly, although not exclusively, relates to scavenging oxygen in packaging, for example bottles. Preferred embodiments relate to a formulation for scavenging oxygen, its incorporation into a composition and its use.

Demand exists for packaging that can preserve or extend the shelf life of foods, beverages, and other products that can be susceptible to degradation or spoilage by oxidation between production and consumption at a later time. However, neat PET does not possess the level of oxygen barrier properties required for some packaging for foods or beverages. Thus, it is known to use oxygen scavengers to enhance the oxygen barrier properties of PET packaging.

There is a trade-off between enhancing oxygen barrier properties and negatively impacting the high transparency of neat PET. Undesirably, increasing the loading level of oxygen scavengers in PET, in order to enhance the oxygen barrier properties, tends to decrease transparency (i.e. increase haze) of the PET.

It is known to enhance oxygen barrier properties of PET by addition of a polyamide, especially polyxylylene adipamide (MXD-6). However, because PET and MXD-6 are such dissimilar materials, a monolayer container comprising PET/MXD-6 with substantially pure PET would detrimentally affect the optical properties of the recycle stream. Consequently, containers comprising PET/MXD-6 may be segregated from other containers and may then be recycled to produce lower quality recycled PET.

There is a need for an oxygen scavenging formulation which can be used to produce very high levels of oxygen scavenging in a container, whilst not significantly affecting optical properties. In this case, bottles incorporating such a formulation could be directly recycled with substantially pure PET bottles which would be highly advantageous.

It is an object of the present invention to address the above-described problem.

According to a first aspect of the invention, there is provided a formulation for scavenging oxygen, said formulation comprising:
(A) an oxygen-scavenging copolymer;
(B) an oil, wherein said oil is selected from:
   (a) olive oil;
   (b) macadamia oil;
   (c) avocado oil;
   (d) bataua oil;
   (e) gevuina oil;
   (f) an oil PQ comprising:
      (i) less than 25% of linoleic acid; and/or
      (ii) less than 10% of linolenic acid; and/or
      (iii) greater than 40% of oleic acid; and/or
      (iv) greater than 40% of monounsaturated fatty acids; and/or
      (v) less than 40% of polyunsaturated fatty acids; and/or
      (vi) at least 0.1% of squalene;
   (g) an oil RS comprising at least 20% of a glycerol oleate.

A reference to “ppm” or “parts-per-million” herein (or cognate expression) refers to the parts per million of a specified material by weight.

In an embodiment, said oil may be selected from any oil in (B)(a) to (f).

The % of components in oils, for example in an oil described in (B), may be assessed by GC-HRMS. Analysis may be as described in, for example, “Column Selection for the Analysis of

Fatty Acid Methyl Esters; Authors: Frank David, Pat Sandra, Allen K Vickers. Agilent Technologies 5989-3760EN and the citations therein. The method involves derivatization of fatty acids to methyl esters as described in W. W. Christie, “Gas Chromatography and Lipids, A Practical Guide”, (1989), The Oily Press, Ayr, Scotland (ISBN 0-9514171-O-X) and then analysis of the fatty acid methyl esters (FAMEs).

Any grade of olive oil, macadamia oil, avocado oil, bataua oil, gevuina oil and oil PQ, for example virgin, extra virgin or highly refined, may be selected.

Said olive oil may include less than 25% of linoleic acid, preferably less than 15%, more preferably less than 10%. Said olive oil may include at least 1%, preferably at least 3%, of linoleic acid.

Said olive oil may include less than 5.0% of linolenic acid, preferably less than 2.0%, more preferably less than 1.0%. Said olive oil may include at least 0.1%, preferably at least 0.3%, of linolenic acid.

Said olive oil may include at least 40% of oleic acid, preferably at least 50%, more preferably at least 65%. Said olive oil may include less than 85%, preferably less than 82%, of oleic acid.

Said olive oil may include at least 40% of monounsaturated fatty acids, preferably at least 50%, more preferably at least 65%, Said olive oil may include less than 85%, preferably less than 82%, of monounsaturated fatty acids.

Said olive oil may include less than 13%, preferably less than 11%, of polyunsaturated fatty acids, Said olive oil may include at least 3% of polyunsaturated fatty acids, for example at least 4%, of polyunsaturated fatty acids.

Said olive oil may include less than 10%, preferably less than 5%, of compounds with more than two, double bonds.

Said olive oil may include at least 0.05% of squalene, preferably at least 0.1%. Said olive oil may include less than 2.0%, preferably less than 1.0%, of squalene.

In said olive oil, the sum of the % of linoleic acid and linolenic acid may be less than 25%, preferably less than 17%, more preferably less than 12%. The sum may be at least 1% or at least 3%.

Said macadamia oil may include less than 25% of linoleic acid, preferably less than 15%, more preferably less than 10%. Said macadamia oil may include at least 0.5%, preferably at least 1%, of linoleic acid.

Said macadamia oil may include less than 10% of linolenic acid, preferably less than 5%. Said macadamia oil may include at least 0.05%, preferably at least 0.1%, of linolenic acid.

Said macadamia oil may include at least 40% of oleic acid, preferably at least 45%, more preferably at least 50%. Said macadamia oil may include less than 80%, preferably less than 70%, of oleic acid.

Said macadamia oil may include at least 40% of monounsaturated fatty acids, preferably at least 50%, more preferably at least 60%, Said macadamia oil may include less than 85%, preferably less than 82%, of monounsaturated fatty acids.

Said macadamia oil may include less than 13%, preferably less than 11%, of polyunsaturated fatty acids. Said macadamia oil may include at least 1% of polyunsaturated fatty acids.

Said macadamia oil may include less than 10%, preferably less than 5%, of compounds with more than two, double bonds.

Said macadamia oil may include less than 2.0%, preferably less than 1.0%, of squalene.

In said macadamia oil, the sum of the % of linoleic acid and linolenic acid may be less than 25%, preferably less than 17%, more preferably less than 12%. The sum may be at least 1%.

Said oil PQ may include less than 25% of linoleic acid, preferably less than 15%, more preferably less than 10%. Said oil PQ may include at least 1%, preferably at least 3%, of linoleic acid.

Said oil PQ may include less than 10% of linolenic acid, preferably less than 5%. Said oil PQ may include at least 0.1%, preferably at least 0.3%, of linolenic acid.

Said oil PQ may include at least 40% of oleic acid, preferably at least 45%, more preferably at least 50 wt %. Said oil PQ may include less than 80%, preferably less than 70%, of oleic acid.

Said oil PQ may include at least 40% of monounsaturated fatty acids, preferably at least 50%, more preferably at least 60%. Said oil PQ may include less than 85%, preferably less than 80%, of monounsaturated fatty acids.

Said oil PQ may include less than 50%, preferably less than 30%, more preferably less than 15%, especially less than 10%, of polyunsaturated fatty acids. Said oil PQ may include at least 2% of polyunsaturated fatty acids.

Said oil PQ may include less than 30%, preferably less than 20%, more preferably less than 15%, especially less than 10%, of compounds with more than two, double bonds.

Said oil PQ may include at least 0.1% of squalene, preferably at least 0.2%. Said oil PQ may include less than 2.0%, preferably less than 1.0%, of squalene.

In said oil PQ, the sum of the % of linoleic acid and linolenic acid may be less than 25%, preferably less than 17%, more preferably less than 12%, especially less than 6%. The sum may be at least 1% or at least 2%.

Said oil PQ may include at least two, preferably at least four, preferably each of characteristics (f)(i) to (vi) referred to. Said oil PQ preferably includes at least characteristics (f)(i) to (iii) referred to.

Said oil PQ preferably has the following characteristics:
less than 25% of linoleic acid;
less than 10% of linolenic acid; and
greater than 40% of oleic acid.

Said oil PQ preferably has the following characteristics:
5-1 to 15%, preferably 2 to 10% of linoleic acid;
0.1 to 10%, preferably 0.1 to 5%, of linolenic acid; and
40 to 80%, preferably 45 to 70%, of oleic acid.

Said oil PQ preferably has the following characteristics:
greater than 40% of monounsaturated fatty acids;
less than 40% of polyunsaturated fatty acids; and
at least 0.1% of squalene.

Said oil PQ preferably has the following characteristics:
15-40 to 80%, preferably 45 to 75%, of monounsaturated fatty acids;
3 to 30%, preferably 4 to 15%, of polyunsaturated fatty acids; and
0.1 to 5.0%, preferably 0.1 to 4.0%, of squalene.

Said oil RS may include glycerol mono-oleate, glycerol di-oleate and/or glycerol tri-oleate. The sum of the % of glycerol mono-oleate, glycerol di-oleate and glycerol tri-oleate in said oil RS is preferably at least 70%, at least 90%, at least 95% or at least 98%.

In an embodiment (I), said oil RS may include at least 20%, preferably at least 30%, more preferably at least 35% or at least 39% of glycerol mono-oleate. In some cases, said oil RS May include at least 90%, at least 95%, at least 99% or about 100% of glycerol mono-oleate. Suitably, said oil RS may include less than 90%, less than 70%, or less than 50%, of glycerol mono-oleate. In embodiment (I), said oil RS may be monoolein, for example as hereinafter described.

In embodiment (I), oil RS may include glycerol mono-oleate as the oil present in the highest amount. The balance may comprise other glycerol esters, for example, other glycerol oleates. It may include 5 to 45% of glycerol di-oleate and 5 to 45% of glycerol tri-oleate, wherein suitably the sum of the % of di-oleate and tri-oleate is less than 65% or less than 55%.

In an embodiment (II), said oil RS may include at least 20%, preferably at least 30%, more preferably at least 40% or at least 45% of glycerol tri-oleate. In some cases, said oil RS may include at least 90%, at least 95%, at least 99% or about 100% of glycerol tri-oleate. Suitably, said oil RS may include less than 90%, less than 70%, or less than 50%, of glycerol tri-oleate. In embodiment (II), said oil RS may be tri-olein, for example as hereinafter described.

In embodiment (II), oil RS may include glycerol tri-oleate as the oil present in the highest amount. The balance may comprise other glycerol esters, for example, other glycerol oleates. It may include 5 to 45% of glycerol mono-oleate and 5 to 45% of glycerol di-oleate, wherein suitably the sum of the % of mono-oleate and di-oleate is less than 65% or less than 55%.

Said oxygen-scavenging copolymer preferably includes oxygen-scavenging segments. Said oxygen-scavenging copolymer is suitably adapted to be compatible with packaging resins (eg of polyester) so that it can be mixed with standard packaging resins, thus minimizing cost. It is common practice to use copolymers, more specifically copolycondensates, as packaging and bottling materials. For example, even common polyethylene terephthalate (PET) used in bottles for soft drinks often comprises isophthalic linkages in the polymer and thus could be called a copolymer. In order to avoid such ambiguities, the term oxygen scavenging copolymer will be used to designate those polymers which have oxygen scavenging moiety (OSM) segments, and unmodified PET is defined as a homopolymer or copolymer that is devoid of OSM segments.

Said oxygen-scavenging copolymer preferably includes polycondensate segments (and preferably said copolymer predominantly comprises polycondensate segments) and OSM segments (and preferably said copolymer includes a lesser wt % of OSM segments compared to the wt % of polycondensate segments).

The OSM segments need be present only in an amount necessary to impart the degree of oxygen scavenging capacity needed for a particular application. Said OSM segments are preferably comprised of polyolefin oligomer segments which have been incorporated into the oxygen-scavenging copolymer. However, other oxygen-scavenging moiety segments such as polypropylene oxide oligomers, methyl pendant aromatic compounds or others that one skilled in the art may readily determine, may be included in the oxygen-scavenging copolymer.

Said oxygen-scavenging copolymer preferably includes at least 80 wt % of polyester segments (e.g. polyethylene terephthalate segments) based on the weight of said oxygen-scavenging copolymer. As described hereinafter, the formulation of the first aspect may be mixed with unmodified polyester (e.g. PET) to producing a packaging article. Since the oxygen-scavenging copolymer comprises mainly polyester segments, such as PET segments, the properties of the oxygen-scavenging copolymer formed may remain very similar to that of the unmodified polyester (e.g. PET) which is used to form the packaging article. In addition, the preferred oxygen-scavenging copolymer remains an integral part of the packaging article due to the compatibility of the oxygen-scavenging copolymer with polyester (eg PET). In fact, the oxygen-scavenging copolymer may undergo transesterification with the unmodified PET during the packaging fabrication process. This creates a package in which the oxygen scavenging copolymer and the unmodified PET cannot be physically separated. However, due to the similarity between the unmodified polyester and the oxygen-scavenging copolymer, packaging incorporating the two materials can readily be recycled with the general recycle stream.

Said oxygen-scavenging copolymer may include 0.5 to 20 wt %, preferably 2 to 15 wt %, more preferably 5 to 10 wt % of OSM segments, based on the weight of the copolymer.

The OSM segments of the oxygen-scavenging copolymer may be produced by reaction of an OSM segments precursor with a polyester. The OSM segments precursor may be at least singly functionally terminated with a group capable of entering into polycondensation polymerization and/or capable of reaction with previously formed polyester moieties to form new covalent bonds. Alternately, the OSM segments precursor can react with polymer end groups to provide a copolymer structure. A functionally terminated OSM segments precursor may be represented by Formula 1.

X—(OSM)—Y Formula 1

Double functionality is shown in Formula 1 as one possibility, but the OSM segments precursor may be singly functionally terminated or functionalized to a degree greater than two. Those of ordinary skill in the art will recognize that the commercial availability of functionally terminated OSM segments precursors will obviate the need to add such functionalization. The OSM segments precursors of Formula 1 are suitably selected to be readily oxidizable at ambient temperature, such that its auto-oxidation does not result in the generation of significant volatile or extractable by-products. Preferred OSM segment precursors include polyolefin oligomers of molecular weight 100 to 10,000, polypropylene oxide oligomers, or methyl pendant aromatic compounds as defined in U.S. Pat. No. 6,346,308.

Said OSM segments precursor may include a polybutadiene moiety. A polybutadiene moiety, when incorporated as segments in a said oxygen-scavenging copolymer, may advantageously provide suitable oxygen scavenging. Especially preferred is an OSM segment derived from unhydrogenated polybutadiene oligomer of MW 1000-3,000. In Formula 1, X and Y are typically the same and may be any species capable of entering into polycondensation and/or transesterification, for example with a polyester. A non-limiting list of possible species represented by X or Y includes OH, COOH, NH2, epoxides, and substituted derivatives thereof capable of entering into step-growth, condensation and/or transesterification reactions, for example with a polyester.

In one preferred embodiment, said oxygen-scavenging copolymer includes OSM segments derived from a polyolefin oligomer and/or which includes a polyolefin oligomeric chain. In an especially preferred embodiment, said oxygen-scavenging copolymer includes OSM segments derived from a polybutadiene oligomer and/or which includes a polybutadiene oligomeric chain. The aforementioned OSM segments are suitably covalently bonded to polyester, for example PET segments, of the oxygen-scavenging copolymer.

Said oxygen-scavenging copolymer may include moieties derived from a chain extending or cross-linking agent. Said copolymer may include 0.1 to 3 wt %, for example 0.6 to 1.3 wt %, of such moieties based on the weight of the oxygen-scavenging copolymer. A preferred chain extending agent or cross-linking agent is pyromellitic dianhydride (PMDA). The inclusion of chain extending or cross-linking agents preferably serves to prevent molecular weight degradation, thus increasing polymer melt viscosity, and maintaining the glass transition temperature of the oxygen-scavenging copolymer. Higher glass transition temperatures may be of significance because the oxygen-scavenging copolymer may exist as a solid below the glass transition temperature and can be formed into films and other packaging articles which retain their shape and mechanical integrity at near ambient temperatures (i.e. about-20 to 60 °C). The oxygen-scavenging copolymers described are suitably able to scavenge oxygen at temperatures both above and below their glass transition temperature.

Oxygen-scavenging copolymers as described may be prepared by known batch or continuous processes. Those of ordinary skill in the art will recognize that the terminal functionality of the OSM segments precursor need not be identical to the functionality of the replaced monomer so long as reactive incorporation proceeds. For example, in the production of PET, terephthalic acid is copolymerized with ethylene glycol. In such instance, substitution of the desired molar equivalent amount of the dihydroxy terminated species of Formula 1 (i.e. substitution for an equivalent molar amount of ethylene glycol) in the polycondensation reaction would result in a modified polyester having some OSM segments in the copolymer at the expense of fewer ethylene segments.

Applicants' preferred method for preparation of the oxygen scavenging copolymers is by reactive extrusion since it allows for greater flexibility at later stages in the overall scheme of production of oxygen scavenging bottles and packaging articles. Preparation of the copolymers by reactive extrusion is disclosed in detail in U.S. Pat. No. 6,083,585 which is hereby incorporated by reference.

In a preferred embodiment, an oxygen-scavenging copolymer may be made by reactive extrusion of a mixture comprising about 90 wt % PET (or PET copolymer containing naphthalate, isophthalate, etc.) and about 10 wt % unhydrogenated hydroxyl-terminated polybutadiene oligomer. The molecular weight of the hydroxyl-terminated oligomer may be in the range of 100 to 10,000. PMDA may be added to this reaction mixture in the range of about 0.5-2.0 wt %, preferably 0.75-1.5 wt %.

An especially preferred oxygen-scavenging copolymer may comprise about 80 to 90 wt % PET segments, about 5-12 wt % polybutadiene segments and 0.1-2.0 wt % PMDA-derived moieties.

In said formulation for scavenging oxygen, the ratio of the wt % of oxygen-scavenging copolymer divided by the wt % of oil (including each oil referred to in (B), especially the oils referred to in (B)(a) to (f)) may be at least 1.0. It may be less than 30 or less than 15 or less than 11. Said ratio is preferably in the range 1 to 30, preferably 1 to 15, more preferably 2 to 11.

In said formulation for scavenging oxygen, the sum of the wt % of oxygen-scavenging copolymer and the wt % of oil (including each oil referred to in (B), especially the oils referred to in (B)(a) to (f))) is suitably at least 30 wt %, preferably at least 35 wt %, more preferably at least 40 wt %.

Preferably, said formulation includes at least 3 wt % of oil. Said formulation may include 3 to 25 wt % of said oil, more preferably 4 to 15 wt % of said oil. Preferably, said formulation includes up to 90 wt % of said oxygen-scavenging copolymer. Said formulation may include 25 to 90 wt % of said oxygen-scavenging copolymer, more preferably 30 to 86 wt % of said oxygen-scavenging copolymer.

Preferably, in said formulation, the sum of the wt % of olive oil, macadamia oil, avocado oil, bataua oil and gevuina oil is at least 3 wt % and may be in the range 3 to 20 wt %, preferably in the range 4 to 15 wt %. Preferably, in said formulation the sum of the wt % of oxygen scavenger copolymer referred to in (A), olive oil, macadamia oil, avocado oil, bataua oil and gevuina oil is at least 35 wt %, preferably at least 40 wt %.

Preferably, in said formulation, the sum of the wt % of olive oil and macadamia oil is at least 3 wt % and may be in the range 3 to 20 wt %, preferably in the range 4 to 15 wt %. Preferably, in said formulation the sum of the wt % of oxygen scavenger copolymer referred to in (A), olive oil, and macadamia oil is at least 35 wt %, preferably at least 40 wt %.

Preferably, in said formulation the sum of the wt % of oxygen scavenger copolymer referred to in (A) and is at least 35 wt %, preferably at least 40 wt %.

Said formulation for scavenging oxygen may further include a transition metal, for example a transition metal salt. The transition metal may be cobalt, for example derived from cobalt stearate.

Said formulation may include less than 1.0 wt %, preferably less than 0.6 wt %. more preferably less than 0.3 wt % of cobalt moieties. Said formulation may include at least 0.05 wt %, preferably at least 0.1 wt %. more preferably at least 0.15 wt % of cobalt moieties. Said formulation may include 0.05 to 0.4 wt % of cobalt moieties.

Said formulation for scavenging may include:
25 to 90 wt % (preferably 30 to 86 wt %) of oxygen-scavenging copolymer, which preferably includes polybutadiene segments;
at least 3 wt % (preferably 3 to 20 wt %) of one or a plurality of oils described in (B) above (especially the oils referred to in (B)(a) to (f)); and, optionally (but preferably),
at least 0.05 wt % (preferably 0.05 to 0.4 wt %) of cobalt moieties.

Said formulation for scavenging may include:
25 to 90 wt % (preferably 30 to 86 wt %) of oxygen-scavenging copolymer, which preferably includes polybutadiene segments;
olive oil and/or macadamia oil, wherein the sum of the wt % of olive oil and macadamia oil in the formulation is at least 3 wt % (preferably 3 to 20 wt %); and, optionally (but preferably),
at least 0.05 wt % (preferably 0.05 to 0.4 wt %) of cobalt moieties.

Said formulation for scavenging may include:
25 to 90 wt % (preferably 30 to 86 wt %) of oxygen-scavenging copolymer, which preferably includes polybutadiene segments;
at least 3 wt % (preferably 3 to 20 wt %) olive oil; and, optionally (but preferably),
at least 0.05 wt % (preferably 0.05 to 0.4 wt %) of cobalt moieties.

Said formulation for scavenging oxygen may be provided in a range of different forms. In one embodiment, said formulation may comprise a single mass comprising the components described, wherein the single mass may be a substantially homogenous mixture or a heterogenous mixture. The single mass may be in a solid form, for example in the form of pellets. In this case, an individual pellet may include said oxygen-scavenging copolymer and said oil; and suitably substantially each pellet in said single mass is as described. In another embodiment, said formulation for scavenging may comprise separate first and second components, wherein said first component may comprise said oxygen-scavenging copolymer and, optionally, said transition metal (when provided); and said second component comprises said oil. In this case, the first and second components may be brought together when the components are contacted with a packaging resin (eg of polyester) which is arranged to provide the majority of the structure of packaging material in which the formulation for scavenging oxygen is utilised. In a further embodiment, the formulation may comprise a blend which comprises a first component, wherein said first component may comprise said oxygen-scavenging copolymer and, optionally, said transition metal (when provided); and a second component which comprises said oil, optionally in combination with a carrier, for example a solid carrier for said oil. The blend may be a salt and pepper blend. It may comprise a first solid masterbatch which includes said oxygen-scavenging polymer (and optional catalyst); and a second solid masterbatch which includes said oil and a solid carrier (eg polyester such as PET); wherein the first and second masterbatches (e.g. in solid or granular form) are blended to define a salt and pepper blend.

Alternatively, said formulation for scavenging oxygen may comprise a liquid, for example a liquid masterbatch.

Said formulation, for example one or more of the masterbatches referred to, may include additional additives, for example toners.

Said formulation may be added to a packaging resin (eg of a polyester, such as PET) to define a composition which may be formed, for example by melt-processing, into a packaging article, for example a preform for a bottle.

The invention extends, in a second aspect, to a composition comprising a packaging resin (eg of a polyester, such as PET); and
(A) an oxygen-scavenging copolymer as described in the first aspect; and
(B) an oil as described in the first aspect, for example being selected from:
   (a) olive oil;
   (b) macadamia oil;
   (c) avocado oil;
   (d) bataua oil;
   (e) gevuina oil;
   (f) an oil PQ as described in the first aspect; and
   (g) an oil RS as described in the first aspect.

Said composition may be formed in a melt-processing apparatus, for example in an injection moulding device. A packaging article, for example a preform for a receptacle (eg a bottle, such as a stretch blow moulded bottle) may be comprised of said composition.

Said composition may comprise:
(I) a packaging resin (eg of a polyester, such as PET);
(II) said oxygen-scavenging copolymer as described in the first aspect;
(III) a said oil as described in (B) of the first aspect (especially the oils referred to in (B)(a) to (f)).

Said composition may include:
at least 93 wt %, for example at least 95 wt %, of packaging resin (eg of a polyester, such as PET);
less than 7 wt % (preferably less than 5 wt % or less than 4 wt %) of said oxygen-scavenging copolymer as described in the first aspect;
less than 2.0 wt % (preferably less than 1.0 wt % or less than 0.6 wt %) of a said oil as described in (B) in the first aspect (especially the oils referred to in (B)(a) to (f)).

Said composition may include at least 0.5 wt % (preferably at least 1.0 wt %) of said oxygen-scavenging copolymer as described in the first aspect; and at least 0.1 wt % (preferably at least 0.2 wt %) of a said oil as described in (B)(especially the oils referred to in (B)(a) to (f) in the first aspect.

Said composition may include:
at least 93 wt %, for example at least 95 wt %, of packaging resin (eg of a polyester, such as PET);
less than 7 wt % (preferably less than 5 wt % or less than 4 wt %) of said oxygen-scavenging copolymer as described in the first aspect;
olive oil, macadamia oil, avocado oil, bataua oil and/or gevuina oil;
wherein the sum of the wt % of olive oil, macadamia oil, avocado oil, bataua oil and gevuina oil in the composition is less than 2.0 wt % (preferably less than 1.0 wt % or less than 0.6 wt %.

Said composition may include at least 0.5 wt % (preferably at least 1.0 wt %) of said oxygen-scavenging copolymer as described in the first aspect; and the sum of the wt % of olive oil, macadamia oil, avocado oil, bataua oil and gevuina oil is at least 0.1 wt % (preferably at least 0.2 wt %).

Said composition may include:
at least 93 wt %, for example at least 95 wt %, of packaging resin (eg of a polyester, such as PET);
less than 7 wt % (preferably less than 5 wt % or less than 4 wt %) of said oxygen-scavenging copolymer as described in the first aspect;
less than 2.0 wt % (preferably less than 1.0 wt % or less than 0.6 wt %) of olive oil.

Said composition may include at least 0.5 wt % (preferably at least 1.0 wt %) of said oxygen-scavenging copolymer as described in the first aspect; and at least 0.1 wt % (preferably at least 0.2 wt %) of olive oil.

Said compositions described preferably includes a transition metal catalyst especially a cobalt catalyst. Said composition preferably include at least 0.001 wt %, preferably at least 0.002 wt % of cobalt moieties. Said compositions preferably include less than 0.05 wt %, preferably less than least 0.01 wt % of cobalt moieties. Said composition may include a cobalt compound, for example cobalt stearate. Said composition preferably includes at least 0.01 wt %, preferably at least 0.02 wt % of said cobalt compound. Said composition preferably include less than 0.5 wt %, preferably less than least 0.1 wt % of said cobalt compound.

Said composition suitably includes less than 5 wt %, preferably less than 1 wt %, more preferably about 0 wt % of polyamide; and/or includes less than 5 wt %, preferably less than 1 wt %, more preferably about 0 wt % of MXD6. Advantageously, by avoiding any significant amount of polyamide and/or MXD6 in the composition (which suitably defines packaging material such as a bottle), the packaging material, for example, bottle, can readily be recycled with a main recycle stream, without any significant effect on the optical properties of the recycle stream, whilst the oxygen-scavenging ability of the formulation and/or composition is at a very high level, thereby providing long term protection from deterioration by oxygen for any content of the packaging material, for example bottle.

Said composition of the second aspect may define a packaging material. Said packaging material may define or be a component of a receptacle. A receptacle may comprise an extruded or thermoformed article, such as a tray, for example for food applications. Alternatively, the receptacle may be, for example, a preform for a bottle (a preform suitably being a test-tube shaped article which is stretch blow moulded to define a bottle) or a bottle per se. Preferred receptacles, for example, preforms or bottles, are monolayer preforms or bottles. Preferably, a receptacle, for example, a preform or bottle (suitably excluding any closure thereof) comprises at least 90 wt %, more preferably at least 95 wt %, especially at least 99 wt %, of said composition.

According to a third aspect of the invention, there is provided a method of making a packaging article, for example a receptacle such as a preform for a bottle or a bottle per se, the method comprising:
(I) contacting an oxygen-scavenging copolymer, an oil as described in (B) in the first aspect and a packaging resin (eg of a polyester, such as PET); and
(II) melt-processing the components referred to in (I) to define the packaging article.

Said oxygen-scavenging copolymer, said oil and said packaging resin may independently be as described in the first or second aspects.

Said packaging article may have a composition as described in the second aspect.

Said receptacle may be as described in the second aspect.

The method may comprise contacting a formulation as described in the first aspect with a packaging resin (eg of a polyester, such as PET); and suitably melt-processing the mixture as described in (II).

Said method may comprise selecting at least 95 wt %, preferably at least 97 wt %, of packaging resin (eg of a polyester, such as PET), relative to the wt % of the packaging article, excluding any closure thereof, defined as 100 wt %. The balance (up to 100 wt %) of the packaging article may be defined by said formulation of the first aspect.

The method is preferably a method of making a packaging article, for example a receptacle such as a preform for a bottle or a bottle per se which can be directly recycled with substantially pure PET in accordance with the European PET Bottle Platform (EPBP) protocol. For example, the packaging article may be assessed as described in Examples 21 to 23.

The invention extends, in a fourth aspect, to a method of recycling a packaging article, the method comprising:
selecting a packaging article as described in the second aspect and/or made as described in the third aspect; and
contacting the packaging article or fragments thereof with other PET to produce a mixture.

The mixture may include 5 to 50 wt % of said packaging article or fragments thereof and 50 to 95 wt % of other PET. The other PET may be PET which includes no colorant. It preferably includes no oxygen scavenger compound. It may be virgin PET.

The invention extends, in a fifth aspect, to recycled PET produced as described in the fourth aspect.

In a sixth aspect, there is provided the use of the formulation of the first aspect for scavenging oxygen and for producing a composition which can be recycled with virgin PET to produce a mixture which has a b* less than a predetermined level. The b* may be assessed as described in Examples 21 to 23. In a preferred embodiment, the difference in b* between virgin PET and a compounded mixture comprising 25 wt % of said composition and 75 wt % virgin PET is preferably less than 1.5 b* units, as described in Assessment 3 and Examples 21 to 23.

Any aspect of any invention described herein may be combined with any other aspect of any invention described herein mutatis mutandis.

Specific embodiments of the invention will now be described, by way of example, with reference to the accompanying figures in which:

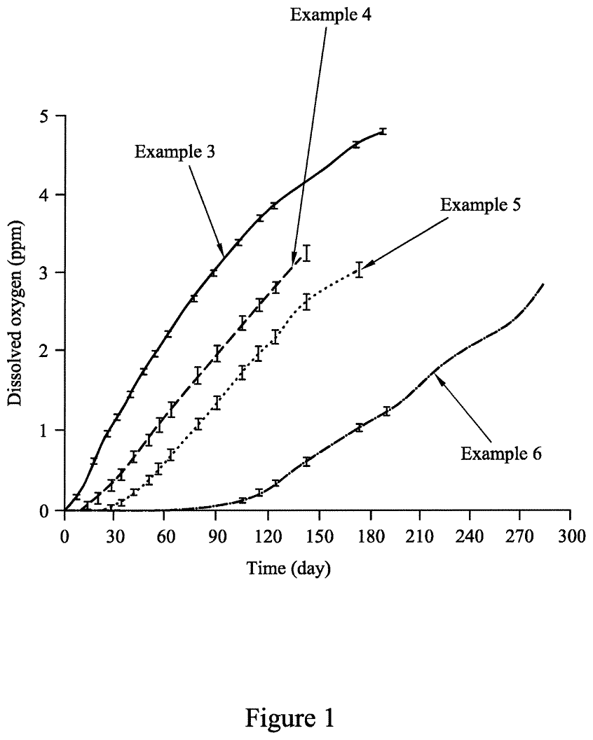

FIG. 1 is a graph which provides Ingress Oxygen Scavenging Test results for Examples 3 to 6;

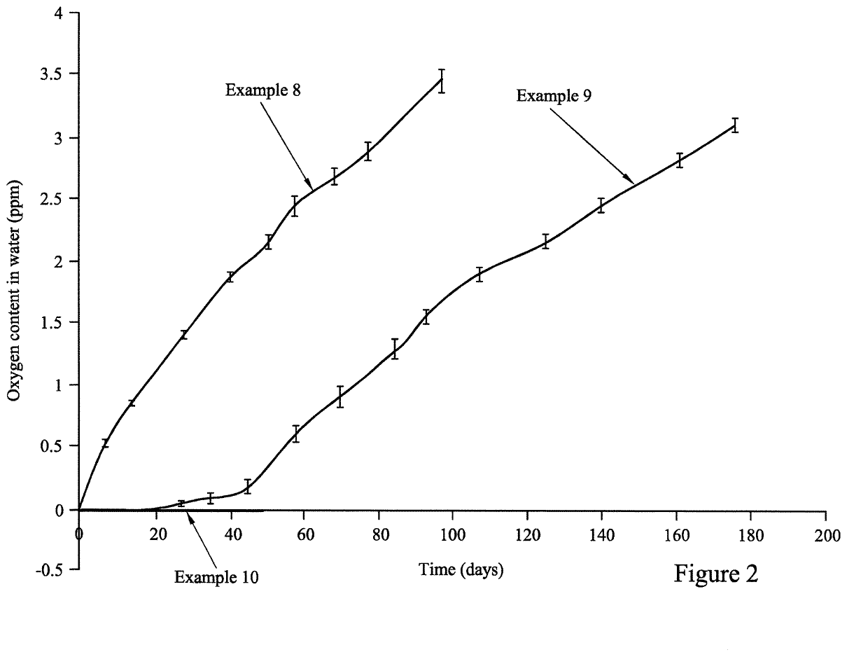

FIG. 2 is a graph which provides Ingress Oxygen Scavenging Test results for Examples 8 to 10;

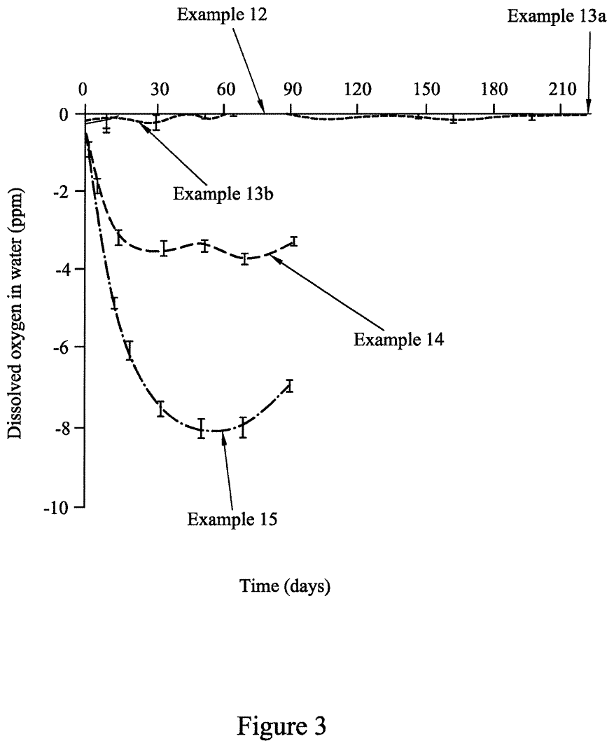

FIG. 3 is a graph which provides Pulldown Oxygen Scavenging Test results for Examples 12 to 15;

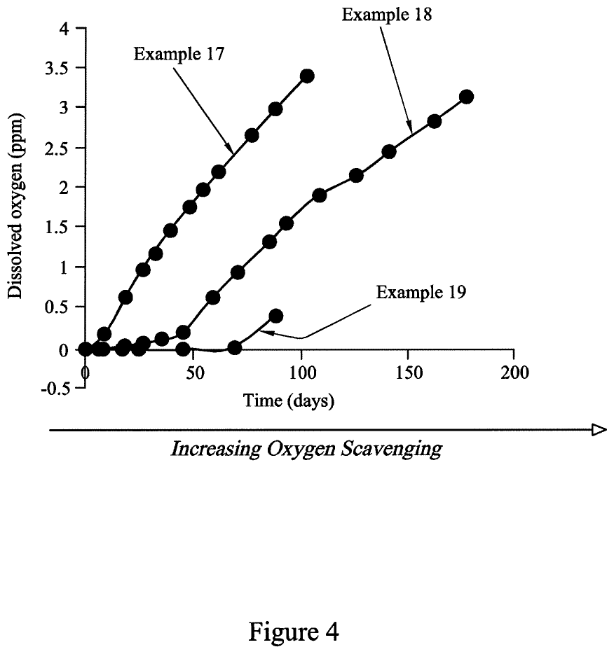

FIG. 4 is a graph which provides Ingress Oxygen Scavenging Test results for Examples 17 to 19;

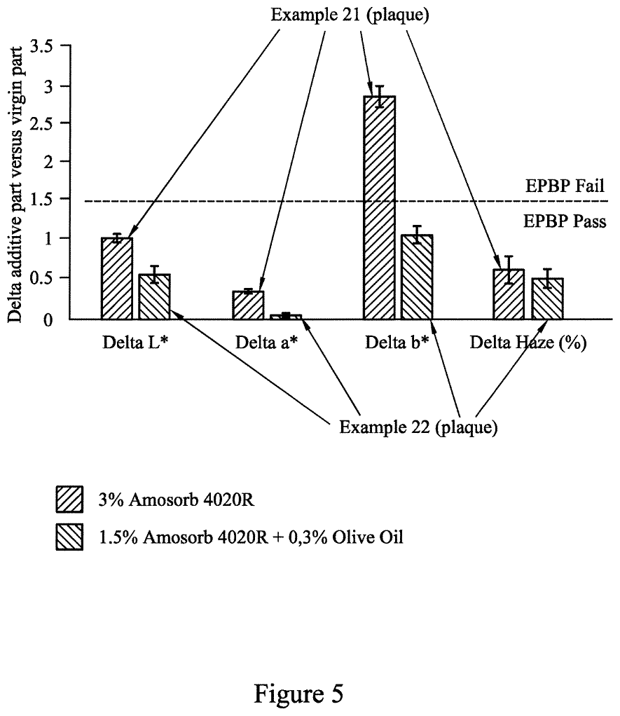

FIG. 5 provides Lab Colour values of plaques of Examples 21 and 22;

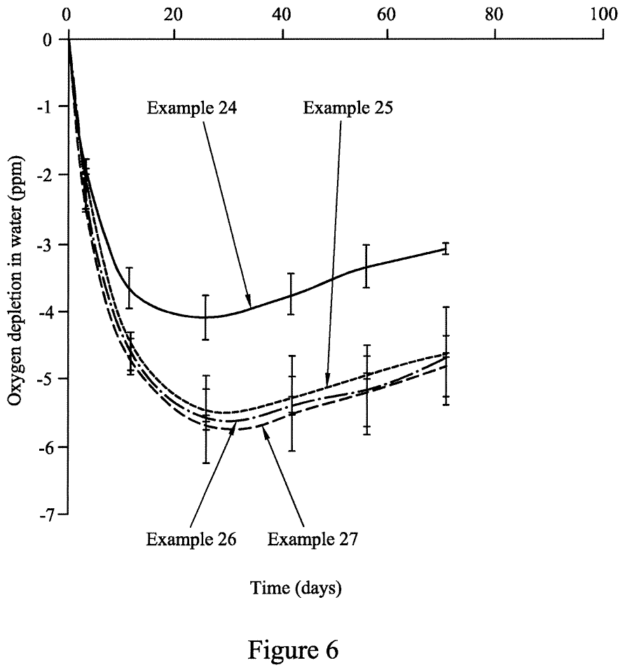

FIG. 6 is a graph which provides Pulldown Oxygen Scavenging Test results for Examples 24 to 27;

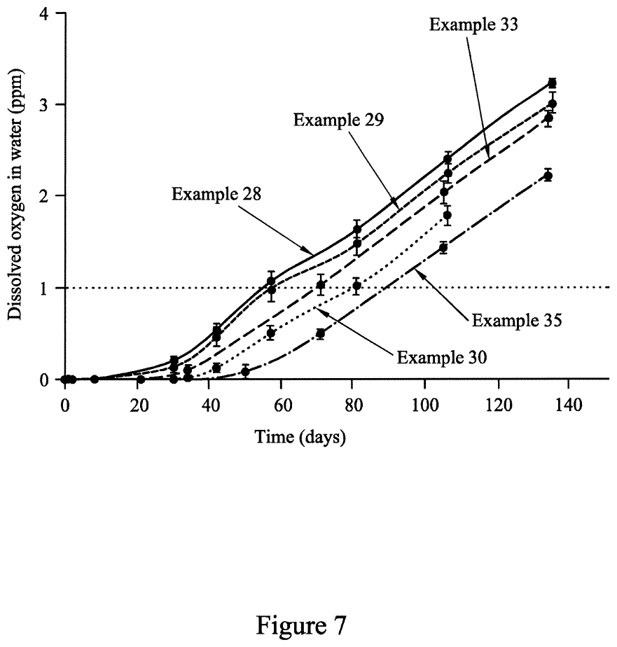

FIG. 7 is a graph which provides Ingress Oxygen Scavenging Test results for Examples 28 to 30, 33 and 35; and

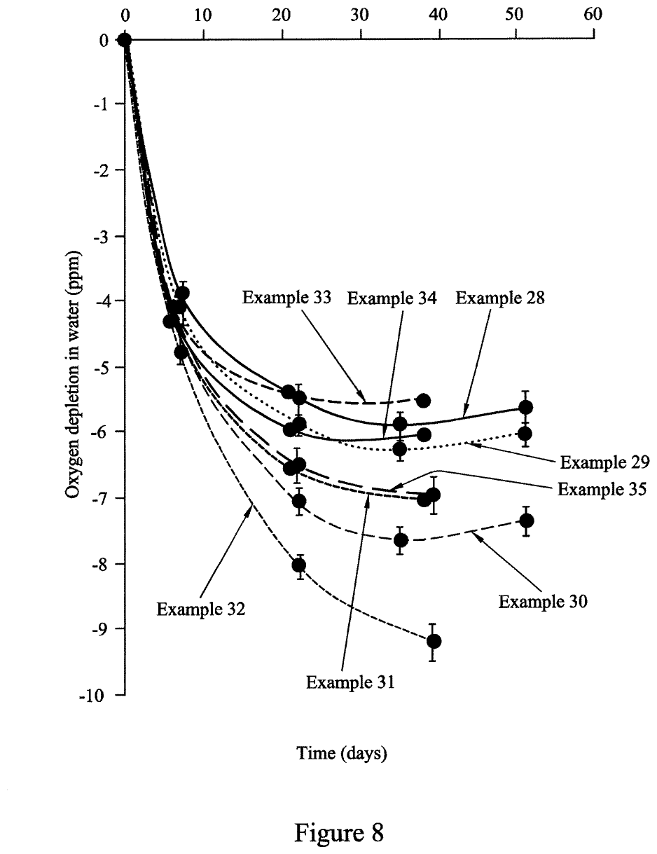

FIG. 8 is a graph which provides Pulldown Oxygen Scavenging Test results for Examples 28 to 35.

The following materials are referred to hereinafter:

AMOSORB (Trade Mark) 4020G—a commercially-available, non-nylon based, low-haze oxygen scavenger for polyethylene terephthalate (PET). The material is as described in WO2003/035486A1, the content of which is hereby incorporated by this reference, insofar as it describes an oxygen scavenger, referred to as an “oxygen scavenging concentrate (OS concentrate)” in the aforementioned publication.

AMOSORB (Trade Mark) 4020R—a commercially-available, non-nylon based, low-haze oxygen scavenger for polyethylene terephthalate (PET), similar to AMOSORB 4020G and being in accordance with WO2003/035486A1, but optimised for oxygen scavenging in up to 100% recycled PET (rPET).

PET-X—refers to Equipolymers C93, a polyethylene terephthalate (PET) bottle grade polymer.

Olive oil—a non-refined olive oil purchased from Sigma Aldrich.

Macadamia oil—extra virgin, cold-pressed macadamia oil sold under the brand Pure South Press.

Avocado oil—extra-virgin, cold pressed avocado oil sold under the brand name Mokhado.

Bataua oil—unrefined, cold-pressed Bataua oil sold under the brand name Nativilis.

Gevuina oil—Organic, cold-pressed, unrefined gevuina oil sold under the brand name Biopurus.

Monoolein-refers to glycerol mono-oleate from Merck which includes monoolein (ie glycerol mono-oleate) as the component present in the highest amount (about 43%) plus other oleins (glycerol di-oleate at about 23% and glycerol tri-oleate at about 32%).

Triolein—refers to glycerol tri-oleate from Tokyo Chemical Industries which includes >50% glycerol tri-oleate plus a balance comprising glycerol mono-oleate and glycerol di-oleate.

### Assessment 1—“Pulldown” Oxygen Scavenging Testing Procedure

In a “pulldown” test method, oxygen scavenging additives incorporated into bottle walls can be assessed by filling the bottles with oxygen-containing water and monitoring the depletion of dissolved oxygen content over time.

In the method, bottles to be assessed and water (before introduction into the bottles) is stored in a temperature controlled environment (21 °C). Standards of known activity and blank controls (virgin PET) are assessed alongside test samples to verify the test method set-up. Note: If O₂ depletion is observed in blank virgin PET bottles over a test period (eg over 14 days of testing) there could be algae/microorganisms in the water and sample testing will have to be repeated. This may occur if insufficient biocide is added.

The method may then comprise the following steps:
(i) A bucket is filled with tap water and biocide (polyhexamethylene biguanide PHMB)(~1 ml biocide in 5 litres water) and covered with a lid. The water is left for about 24 hours in a temperature controlled room for temperature and dissolved oxygen content to equilibrate.
(ii) Stretch-blow moulded bottles, incorporating any oxygen scavenging additives, are made on the same day or day before putting on test. The bottles are stored in sealed aluminum bags purged with N₂ before use.
(iii) Before a bottle is filled with the prepared biocide water, an opTech Platinum sensor dot (part of a commercially available oxygen measurement system from Ametek Mocon) is attached onto the inside bottle wall using tweezers or other such tool. Then the following steps are undertaken:
   (a) Each bottle is filed to the brim with the prepared water/biocide leaving no headspace.
   (b) A bottle closure is placed on each bottle and tightened using a bottle cap torque meter to the recommended Nm, depending on closure specification.
   (c) Once all bottles to be assessed had been prepared, an initial reading of dissolved O₂ content is taken. This should be ~10 ppm.
   (d) Bottles are stored in a temperature controlled room and measurements are taken every 2-3 days for 14 days.
   (e) Further measurements may be taken after the specified 14 days if desired.

### Assessment 2—“Ingress” Oxygen Scavenging Testing Procedure

In an “ingress” test method, oxygen scavenging additives incorporated into bottle walls can be assessed by filling the bottles with deoxygenated water and monitoring the dissolved oxygen content of the water as it increases (ingress through bottle wall) over time.

As a standard method for measuring scavenging activity, measurements may be taken at regular intervals every few days up to 14 days and every few weeks thereafter. The frequency of measurements is dependent on the expected shelf life extension the additive can impart. The test is complete when the dissolved oxygen reaches a level of 3 ppm.

The method may then comprise the following steps:
(i) A glove box set-up is required that contains a tank/container for water, a nitrogen supply and a vacuum system. There should be a nitrogen supply to the tanks to bubble through the water. The glove box should also contain weighing scales, bottle lids, torque meter and a dissolved oxygen sensor (probe inserted into water tank).
(ii) Stretch-blow moulded bottles, incorporating any oxygen scavenging additives, are made on the same day or day before putting on test. An appropriate oxygen measurement sensor (such as an OpTech Platinum sensor dot) is attached into the inside of the bottle samples using tweezers or other such tool. The bottles are stored in sealed aluminium bags purged with N₂ before use.
(iii) Standards of known activity (e.g 3% 4020G in virgin PET) and blank controls (virgin PET) may be assessed alongside test samples to verify test method set-up. Note: If scavenging is observed in blank virgin PET bottles there could be algae/microorganisms in the water and sample testing will have to be repeated. This can occur if insufficient biocide is added.
(iv) The tank/container in the glove box is filled with tap water and biocide (polyhexamethylene biguanide PHMB)(~1 ml biocide in 5 litres water).
(v) All equipment and sample bottles are placed inside the glove box before sealing.
(vi) Nitrogen is bubbled through the water up to the maximum safe pressure, followed by a vacuum up to the lowest maximum safe pressure. This process is repeated multiple times until the oxygen sensor inserted in the water tank reads a dissolved oxygen content below 300 ppb.
(vii) It is ensured there is ambient pressure in the glove box before nominally filling bottles with water/biocide from tank/container (There will be a headspace).
(viii) A bottle closure is placed on each bottle and tightened using a bottle cap torque meter to the recommended Nm, depending on closure specification.
(ix) Once all samples are prepared, the glove box can be opened, samples removed and an initial reading of dissolved O₂ content is taken. This should be <300 ppb (parts-per-billion).
(x) Samples are stored in a temperature controlled room and measurements taken every 2-3 days for 14 days and every few weeks thereafter.

### Assessment 3—Recyclability Assessment

A test was developed to replicate a European PET Bottle Platform (EPBP) test procedure. The test involves the following steps:
(i) A preform, the recyclability of which is to be assessed, is ground and the ground sample (referred to as “additive flake” since it generally includes oxygen scavenging additive) crystallised at 155 °C for 60 minutes in a convection oven.
(ii) The additive flake is placed in a desiccant oven dryer for at least 4 hours and until the moisture of the sample is below 50 ppm.
(iii) A preform, made from virgin PET-X, is ground and the ground sample (referred to as “virgin flake”) crystallised at 155 °C for 60 minutes in a convection oven.
(iv) The virgin flake is placed in a desiccant oven dryer for at least 4 hours and until the moisture of the sample is below 50 ppm.
(v) Additive flake (25 wt %) and virgin flake (75 wt %) are blended, extruded at 285 °C on a single screw extruder and pelletized (referred to as “blended pellets”).
(vi) The blended pellets are crystallised at 155 °C for 60 minutes in a convection oven. The pellets are placed in a desiccant oven dryer for at least 4 hours and until the moisture of the sample is below 50 ppm.
(vii) The crystallised blended pellets together with virgin PET-X (50 wt %) are moulded into 3 mm plaques (referred to as “additive plaques”) on an injection moulding machine.
(viii) Colour values of additive plaques are measured.
(ix) Separate pellets are produced from virgin flake (100 wt %) by extrusion at 285 °C on a single screw extruder followed by pelletization. The pellets are crystallised and dried as described above and moulded into 3 mm plaques (referred to as “virgin plaques”) on an injection moulding machine.
(x) The delta L*, a* and b* between additive plaques and virgin plaques is calculated. Provided the delta b* is less than 1.5 units, the preform is deemed suitable for being recycled with virgin PET.

The following examples illustrate preferred embodiments of the invention.

### Example 1—General Procedure for Preparation of Preforms

25 g, 38 mm neck diameter preforms were manufactured in a Husky GL160 injection moulder, with a two cavity mould installed. PET-X which had been pre-dried to less than 50 ppm moisture was premixed manually with components to be tested and manually added into a hopper installed above the feed throat of the injection moulder machine. A standard PET injection moulding process was employed to produce preforms.

### Example 2—Producing Bottles from Preforms

Preforms made as described in Example 1 were stretch blow moulded using a Sidel SB01 blow moulding machine into a 1 litre cylindrical bottle. A standard blowing process was utilised. The overall power % of the heating ovens was adjusted to achieve a preform temperature of 115°-120 °C as the preform exits the oven and before it enters the blow mould. This is referred to as the blowing temperature.

### Examples 3 to 6—Preparation of Bottles to be Assessed

Following the general procedure described in Example 1, preforms were made having the following compositions (which were prepared by tumble blending the specified components):

| | AMOSORB 4020G | | |
|---|---|---|---|
| Example No. | (wt %) | Olive oil (wt %) | PET-X |
| 3 | 0 | 0 | 100 wt % |
| 4 | 3 | 0 | To 100 wt % |
| 5 | 3 | 0.1 | To 100 wt % |
| 6 | 3 | 0.6 | To 100 wt % |

The preforms were made into bottles as described in Example 2.

### Example 7—Assessment of Bottles of Examples 3 to 6

The bottles of Examples 3 to 6 were assessed as described in Assessment 2 and results are presented in FIG. 1 which shows:
(i) The Example 3 bottle without any oxygen scavenger shows a substantially linear increase in dissolved oxygen and may be regarded as a benchmark against which to assess the other examples.
(ii) The Example 4 bottle shows significant scavenging compared to the Example 3 bottle as would be expected due to incorporation of the commercially available oxygen scavenger.
(iii) The Example 5 bottle shows a significant improvement in oxygen scavenging compared to the Example 4 bottle.
(iv) The Example 6 bottle, including a higher level of olive oil compared to the Example 5 bottle, provides exceptional oxygen scavenging performance with surprisingly little dissolved oxygen being observed for the first 180 days and a low level of dissolved oxygen thereafter.

The observations in relation to the Example 5 and Example 6 bottles may be exploited in a number of ways. For example, a lower amount of relatively costly AMOSORB 4020G may be used in a bottle in favour of cheaper olive oil and a similar level of oxygen scavenging may be achieved as illustrated in Examples 8 to 10. Alternatively, the olive oil may be used to provide increased levels of oxygen scavenging (and therefore improved shelf life) compared to bottles which include the same amount of AMOSORB 4020G.

### Examples 8 to 10—Preparation of Bottles to be Assessed to Illustrate Incorporation of Olive Oil

Following the general procedure described in Example 1, preforms were made having the following compositions:

| | AMOSORB 4020G | | |
|---|---|---|---|
| Example No. | (wt %) | Olive oil (wt %) | PET-X |
| 8 | 0 | 0 | 100 wt % |
| 9 | 3 | 0 | To 100 wt % |
| 10 | 1.5 | 0.3 | To 100 wt % |

The preforms were made into bottles as described in Example 2.

### Example 11-Assessment of Bottles of Examples 8 to 10

The bottles of examples 8 to 10 were assessed as described to in Assessment 2 and results are presented in FIG. 2. The results show that, when olive oil is included, the amount of AMOSORB 4020G can be reduced by half (see Example 10) and the oxygen scavenging performance is still superior to Example 9 which does not include the olive oil.

### Example 12 to 15—Preparation of Bottles to be Assessed to Further Illustrate the Effect of Incorporation of Olive Oil

Following the general procedure described in Example 1, preforms were made having the following compositions:

| | AMOSORB 4020R | | |
|---|---|---|---|
| Example No. | (wt %) | Olive oil (wt %) | PET-X |
| 12 | 0 | 0 | 100 wt % |
| 13a | 0 | 0.6 | To 100 wt % |
| 13b | 0 | 0.6 wt % olive oil | To 100 wt % |
| | | and 45 ppm cobalt | |
| 14 | 3 | 0 | To 100 wt % |
| 15 | 3 | 0.6 | To 100 wt % |

The preforms were made into bottles as described in Example 2.

### Example 16—Assessment of Bottles of Examples 12 to 15

The bottles were assessed as described in Assessment 1 and results are presented in FIG. 3. These show the incorporation of olive oil alone (Example 13a) leads to no significant scavenging activity (compare Examples 12 and 13a, but note the dotted line representing Example 13a is obscured in FIG. 3. For the avoidance of doubt, the line generally extends at a value of zero on the y-axis). Additionally, incorporation of olive oil and 45 ppm cobalt catalyst (Example 13b) leads to no significant scavenging activity (compare Examples 12 and 13b). However, comparing Examples 14 and 15, shows that there is synergy in the combination of AMOSORB 4020R and olive oil. The enhancement in scavenging when olive oil is included is large and the enhancement is even greater than that seen between examples 12 and 14.

### Examples 17 to 19—Preparation of Bottles to be Assessed to Illustrate Incorporation of Macadamia Oil

Following the procedure described for Examples 3 to 6, preforms were made having the following compositions:

| | AMOSORB 4020R | | |
|---|---|---|---|
| Example No. | (wt %) | Macadamia Nut Oil | PET-X |
| 17 | 0 | 0 | 100 wt % |
| 18 | 3 | 0 | to 100 wt % |
| 19 | 3 | 0.3 | to 100 wt % |

The preforms were made into bottles as described in Example 2.

### Example 20—Assessment of Bottles of Examples 17 to 19

The bottles were assessed as described in Assessment 2 and results are provided in FIG. 4 which shows:
(i) The Example 17 bottle without any oxygen scavenger may be regarded as a benchmark.
(ii) The Example 18 bottle shows significant scavenging compared to Example 17 since it incorporates commercially available oxygen scavenger.
(iii) The Example 19 bottle shows a significant improvement in oxygen scavenging compared to the Example 18 bottle.

### Examples 21 and 22—Assessment of Recyclability of Olive Oil-Containing Formulations

Following the general procedure described in Assessment 3, plaques were produced as described in (vii) of Assessment 3 from preforms (the recyclability of which is to be assessed) having the compositions detailed in the table below with 75 wt % PET-X.

| | AMOSORB 4020R | Olive Oil | |
|---|---|---|---|
| Example No. | (wt %) | (wt %) | PET-X |
| 21 | 3.0 | 0 | to 100 wt % |
| 22 | 1.5 | 0.3 | to 100 wt % |

The plaques produced from Examples 21 and 22 will be referred to as Examples 21 (plaque) and 22 (plaque) to distinguish bottle flakes per se.

The plaques were assessed for oxygen scavenging ability and recyclability. It was found that Examples 21 and 22 formulations had comparable oxygen scavenging ability.

Colour assessment of the plaques of Example 21 (plaque) and Example 22 (plaque) as described in Assessment 3, are illustrated in FIG. 5. In the figure, it will be noted that the delta b* for Example 21 (plaque) fails the EPBP test and therefore the flakes of Example 21 would not be suitable to be recycled with virgin PET. In contrast, for Example 22 (plaque), the flakes of Example 22 pass all the EPBP tests and are therefore suitable to be recycled with virgin PET.

### Example 23—Assessment of Recyclability of Macadamia Oil-Containing Formulations

Following the procedure described in Example 20, macadamia oil-containing formulations were assessed and were also found to not only provide high levels of oxygen scavenging, but also to have improved recyclability compared to formulations with equivalent oxygen scavenging ability achieved by use of AMOSORB 4020G alone.

### Examples 24 to 27-Assessment of Other Oils

Following the general procedure described in Example 1, preforms and bottles were made having the following compositions:

| | AMOSORB | | Amount | |
|---|---|---|---|---|
| | 4020R | Identity | of oil | |
| Example No. | (wt %) | of oil | (wt %) | PET-X |
| 24 | 3 | — | — | 100 wt % |
| 25 | 3 | avocado | 0.3 | to 100 wt % |
| 26 | 3 | bataua | 0.3 | to 100 wt % |
| 27 | 3 | gevuina | 0.3 | to 100 wt % |

The bottles were assessed as described in Assessment 1 and results are presented in FIG. 6 which shows enhancements in oxygen scavenging when the specified oils are incorporated with AMOSORB 4020R.

### Examples 28 to 35—Preparation of Bottles to be Assessed to Illustrate Incorporation of Monoolein or Triolein

Following the procedure described for Examples 3 to 6, preforms were made having the following compositions:

| Exam- | AMOSORB | AMOSORB | | | |
|---|---|---|---|---|---|
| ple | 4020R | 4020G | Monolein | Triolein | |
| No. | (wt %) | (wt %) | (wt %) | (wt %) | PET-X |
| 28 | 3 | 0 | 0 | 0 | 100 wt % |
| 29 | 3 | 0 | 0.3 | 0 | to 100 wt % |
| 30 | 3 | 0 | 0 | 0.3 | to 100 wt % |
| 31 | 3 | 0 | 0.6 | 0 | to 100 wt % |
| 32 | 3 | 0 | 0 | 0.6 | to 100 wt % |
| 33 | 0 | 3 | 0 | 0 | to 100 wt % |
| 34 | 0 | 3 | 0.3 | 0 | to 100 wt % |
| 35 | 0 | 3 | 0 | 0.3 | to 100 wt % |

The preforms were made into bottles as described in Example 2.

### Example 35—Assessment of Bottles of Examples 28 to 35

The bottles were assessed as described in Assessments 1 and 2 and results are provided in FIGS. 7 and 8 respectively.

FIG. 7 shows:
(i) The Example 28 bottle with oxygen scavenger alone may be regarded as a benchmark.
(ii) The Example 29 bottle, containing monoolein in addition to the oxygen scavenger of Example 28, shows increased oxygen scavenging compared to Example 28.
(iii) The Example 30 bottle, containing triolein in addition to the oxygen scavenger of Example 28, shows a large increased oxygen scavenging compared to Example 28.
(iv) The Example 33 bottle with oxygen scavenger alone may be regarded as a benchmark.
(v) The Example 34 bottle, containing monoolein in addition to the oxygen scavenger of Example 33, shows increased oxygen scavenging compared to Example 33.
(vi) The Example 35 bottle, containing triolein in addition to the oxygen scavenger of Example 33 shows a large increased oxygen scavenging compared to Example 33.

FIG. 8 shows a similar improvement to oxygen scavenging as described for FIG. 7 and in addition shows improved scavenging when the amount of monoolein or triolein is increased from 0.3 wt % to 0.6 wt % (compare Example 31 with Example 29; and Example 32 with Example 30).

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A formulation for scavenging oxygen, said formulation comprising:
(A) an oxygen-scavenging copolymer; and
(B) an oil, wherein said oil is selected from:
(a) olive oil;
(b) macadamia oil;
(c) avocado oil;
(d) bataua oil;
(e) gevuina oil;
(f) an oil PQ comprising:
(i) less than 25% of linoleic acid; and/or
(ii) less than 10% of linolenic acid; and/or
(iii) greater than 40% of oleic acid; and/or
(iv) greater than 40% of monounsaturated fatty acids; and/or
(v) less than 40% of polyunsaturated fatty acids; and/or
(vi) at least 0.1% of squalene.
(g) an oil RS comprising at least 20% of a glycerol oleate.

2. A formulation according to claim 1, wherein said oil is selected from any oil in (B)(a) to (f).

3. A formulation according to claim 1, wherein: said oil PQ includes less than 25% of linoleic acid; and said oil PQ includes at least 1% of linoleic acid; or
said oil PQ includes less than 10% of linolenic acid; and said oil PQ includes at least 0.1% of linolenic acid.

4. A formulation according to claim 1, wherein:
said oil PQ includes at least 40% of oleic acid; and said oil PQ includes less than 80% of oleic acid.

5. A formulation according to claim 1, wherein:
said oil PQ includes at least 40% of monounsaturated fatty acids; and said oil PQ includes less than 85% of monounsaturated fatty acids.

6. A formulation according to claim 1, wherein:
said oil PQ includes less than 50%, of polyunsaturated fatty acids; and said oil PQ includes at least 2% of polyunsaturated fatty acids.

7. A formulation according to claim 1, wherein:
said oil PQ includes less than 30% of compounds with more than two, double bonds.

8. A formulation according to claim 1, wherein:
in said oil PQ, the sum of the % of linoleic acid and linolenic acid is less than 25% and said sum is at least 1%.

9. A formulation according to claim 1, wherein said oil PQ has the following characteristics:
1 to 15% of linoleic acid;
0.1 to 10% of linolenic acid; and
40 to 80% of oleic acid.

10. A formulation according to claim 1, wherein said oil PQ has the following characteristics:
40 to 80% of monounsaturated fatty acids;
3 to 30% of polyunsaturated fatty acids; and
0.1 to 5.0% of squalene.

11. A formulation according to claim 1, wherein said oxygen-scavenging copolymer includes polycondensate segments and oxygen scavenging moiety (OSM) segments, wherein said OSM segments are comprised of polyolefin oligomer segments which have been incorporated into the oxygen-scavenging copolymer.

12. A formulation according to claim 1, wherein said oxygen-scavenging copolymer includes OSM segments derived from a polybutadiene oligomer and/or which includes a polybutadiene oligomeric chain.

13. A formulation according to claim 1, wherein said oxygen-scavenging copolymer comprises about 80 to 90 wt % PET segments, about 5-12 wt % polybutadiene segments and 0.1-2.0 wt % PMDA-derived moieties.

14. A formulation according to claim 1, wherein, in said formulation for scavenging oxygen, the ratio of the wt % of oxygen-scavenging copolymer divided by the wt % of oil is in the range 1 to 30.

15. A formulation according to claim 1, wherein said formulation for scavenging includes:
25 to 90 wt % of oxygen-scavenging copolymer, which includes polybutadiene segments;
olive oil and/or macadamia oil, wherein the sum of the wt % of olive oil and macadamia oil in the formulation is at least 3 wt %.

16. A formulation according to claim 1, wherein said formulation includes said oil RS and said oil includes glycerol mono-oleate, glycerol di-oleate and/or glycerol tri-oleate.

17. A composition comprising a packaging resin; and
(A) an oxygen-scavenging copolymer as described in claim 1; and
(B) an oil selected from:
(a) olive oil;
(b) macadamia oil;
(c) avocado oil;
(d) bataua oil;
(e) gevuina oil; and
(f) an oil PQ comprising:
(i) less than 25% of linoleic acid; and/or
(ii) less than 10% of linolenic acid; and/or
(iii) greater than 40% of oleic acid; and/or
(iv) greater than 40% of monounsaturated fatty acids; and/or
(v) less than 40% of polyunsaturated fatty acids; and/or
(vi) at least 0.1% of squalene.

18. A composition according to claim 17 which includes:
at least 93 wt %;
less than 7 wt % of said oxygen-scavenging copolymer;
less than 2.0 wt % of said oil.

19. A composition according to claim 18, wherein said composition includes at least 0.5 wt % of said oxygen-scavenging copolymer; and the sum of the wt % of olive oil, macadamia oil, avocado oil, bataua oil and gevuina oil is at least 0.1 wt %.

20. A composition according to any of claim 17, wherein said composition includes less than 1 wt % of polyamide; and/or includes less than 1 wt % of MXD6.

21. A composition according to any of claim 17, wherein said composition defines or is a component of a receptacle, for example a preform for a bottle.

22. A method of making a packaging article the method comprising:
(I) contacting an oxygen-scavenging copolymer and an oil as described in claim 1 and a packaging resin; and
(II) melt-processing the components referred to in (I) to define the packaging article.

23. A method of recycling a packaging article, the method comprising:
selecting a packaging article as described in claim 17; and
contacting the packaging article or fragments thereof with other PET to produce a mixture.

24. (canceled)

25. (canceled)

26. (canceled)
